(19) United States
(12) Patent Application Publication
(10) Pub. No.: US 2017/0144404 A1
(43) Pub. Date: May 25, 2017

(54) SCREEN COVER AND ELECTRONIC DEVICE EMPLOYING SAME

(71) Applicant: HON HAI PRECISION INDUSTRY CO., LTD., New Taipei (TW)

(72) Inventors: FENG-YUEN DAI, Tu-Cheng (TW); CHAU-JIN HU, Tu-Cheng (TW); KUN-CHAN WU, Tu-Cheng (TW)

(21) Appl. No.: 14/982,763

(22) Filed: Dec. 29, 2015

(30) Foreign Application Priority Data
Nov. 24, 2015 (TW) 104139040

(51) Int. Cl. B32B 3/30; G06F 3/044

(52) U.S. Cl. CPC B32B 3/30; G06F 3/044; B32B 2307/412; B32B 2457/208

(57) ABSTRACT

A screen cover is configured to protect a screen of an electronic device. The device includes a screen cover and an optical thin film. The screen cover includes a first surface and a second surface opposite to the first surface. The optical thin film includes a third surface and a fourth surface opposite to the third surface. The third surface is attached to the second surface, and the fourth surface is attached to the screen when in use. The screen cover defines optical microstructure in the fourth surface, and the optical microstructure is adjacent to at least one edge of the fourth surface. The optical microstructure includes at least one groove. An electronic device with the screen cover is also provided.

### FIELD

The present disclosure relates to a screen cover and an electronic device employing the screen cover.

### BACKGROUND

Currently, smart phones, tablet computers and other electronic devices are provided with a display screen. However, edges of the existing screen usually include a border.

### BRIEF DESCRIPTION OF THE DRAWINGS

Implementations of the present technology will now be described, by way of example only, with reference to the attached figures.

FIG. 1 is an isometric view of a screen cover, according to an embodiment.

FIG. 2 is a cross-sectional view taken along II-II line of FIG. 1.

FIG. 3 is an enlarged view of the screen cover of FIG. 2.

FIG. 4 is an isometric view of an electronic device of FIG. 4.

FIG. 5 is a cross-sectional view taken along V-V line of FIG. 4.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

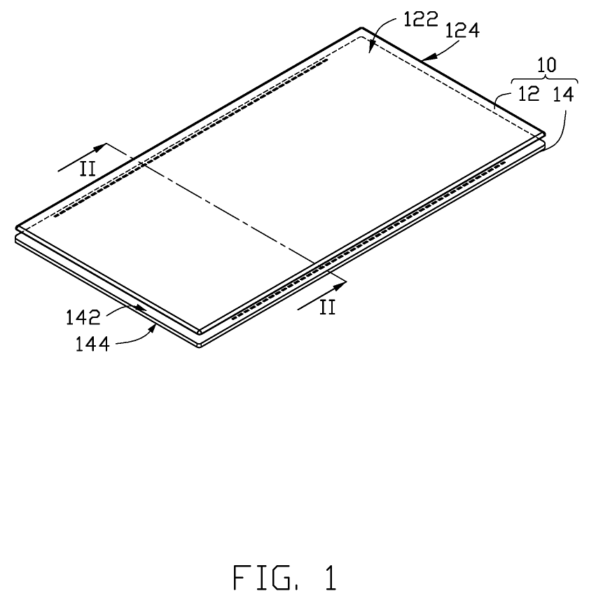

FIG. 1 illustrates a screen cover 10 according to an embodiment.

The screen cover 10 is configured to protect a screen of an electronic device. The screen cover 10 includes a cover 12 and an optical thin film 14. The cover 10 is attached to the optical thin film 14.

The cover 12 includes a first surface 122 and a second surface 124. The second surface 124 is opposite to the first surface 122. The optical thin film 14 includes a third surface 142 and a fourth surface 144. The third surface 142 is opposite to the fourth surface 144.

When the screen cover 10 is being used, the third surface 142 is attached to the second surface 124. The fourth surface 144 is attached to a screen. The first surface 122 is a display screen surface. The cover 12 is transparent; the cover 12 can be made of a transparent glass or a transparent plastic or other conventional transparent material. In at least one embodiment, the optical thin film 14 is an anti-glare film. The anti-glare film can provide uniform emergent light to outside, and the light is formed on the screen.

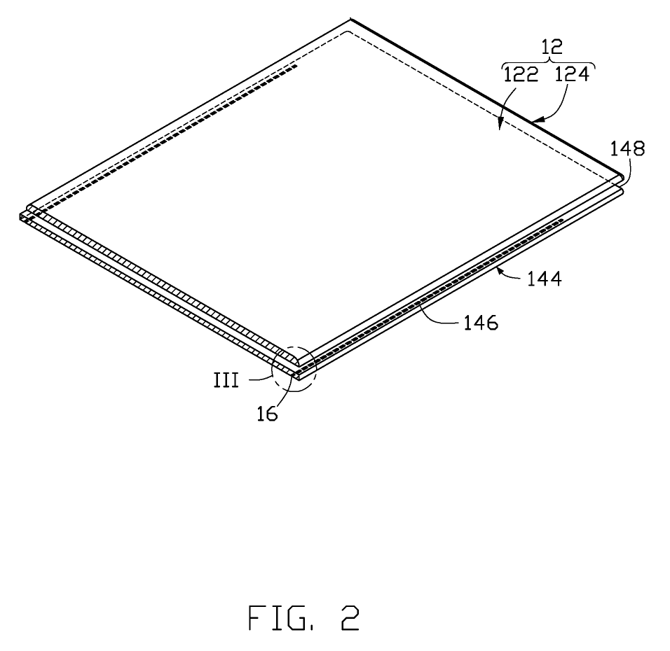

FIG. 2 illustrates a sectional view of the screen cover 10. At least one edge of the fourth surface 144 defines a micro-structure 16. In at least one embodiment, the fourth surface 144 includes two opposite long edges 146 and two opposite short edges 148. Two optical micro-structures are defined adjacent to the two long edges 146 respectively. In other embodiments, the micro-structures 16 can be defined at all adjacent edges of the fourth surface 14, or just defined at one adjacent edge of the fourth surface 14.

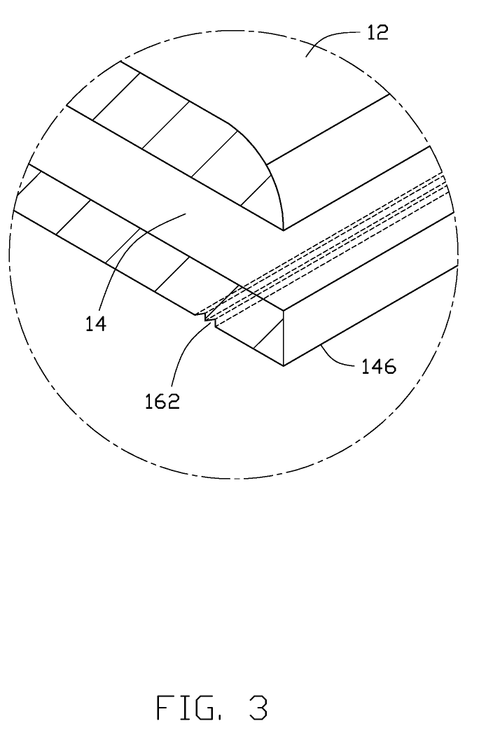

FIG. 3 illustrates an enlarged view of the screen cover 10. Each micro-structure 16 includes two grooves 162; the two grooves 162 are adjacent and parallel to each other. Each groove 162 extends towards the extension direction of the long edge 146.

Each micro-structure 16 can include a single groove 162, or three or more grooves 162. Every two adjacent grooves 162 are parallel and close to each other.

The grooves 162 can be V-shaped, arc groove or other shaped grooves. In at least one embodiment, each micro-structure 16 includes two V-shaped grooves. The top angle of the V-shaped groove can be a sharp corner or an arced angle. The size of the top angle can be 30 degrees, 60 degrees, 90 degrees or at another angle.

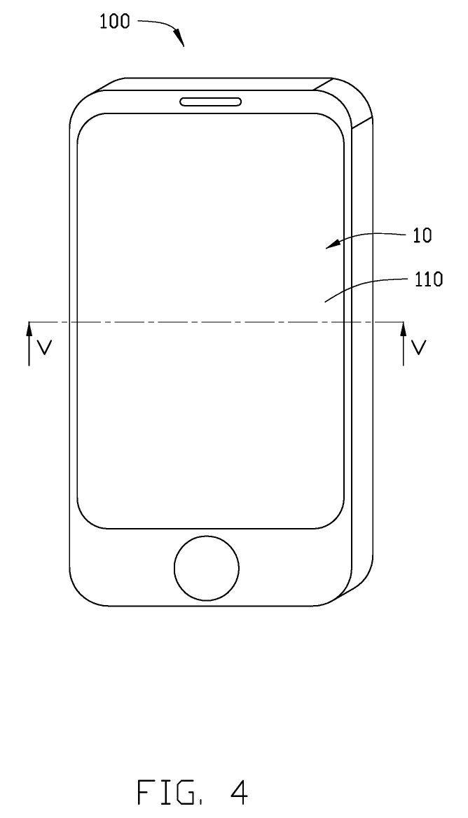

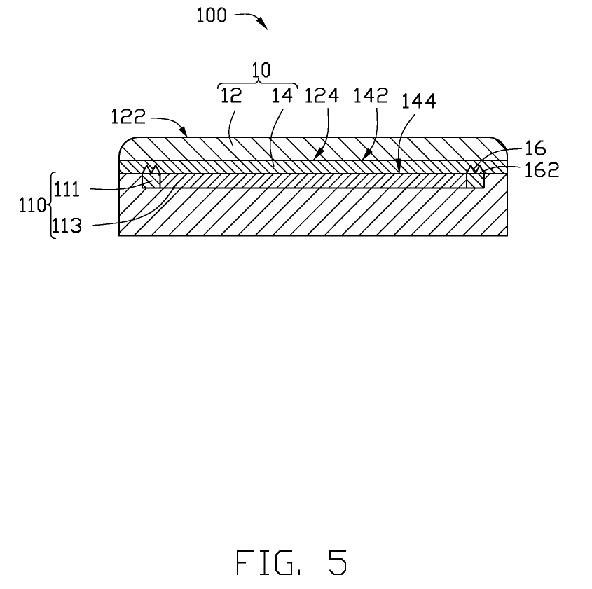

FIGS. 4 and 5 illustrate an electronic device 100 which employs the screen cover 10. The electronic device 100 includes a screen 110. The screen 110 is a display panel, which includes a border 111 and a display screen area 113. The border 111 is set at periphery of the display screen 113. The third surface 142 is attached to the second surface 124. The fourth surface 144 of the optical thin film 14 is attached to the screen 110, and the micro-structure 16 is corresponding to the border 111.

FIG. 5 illustrates that the micro-structure 16 covers the border 111 completely.

The optical thin film 14 defines the micro-structure 16, which makes the screen 110 and the cover 12 produce a micro-refinement visual effect (light which irradiates to the wall of the grooves 162 can be refracted). When the screen 110 is observed through the cover 12, the display screen area 113 can appear larger and the border 111 can be appear narrow and can even be invisible.

The cover 12 is also available for touch screens, such as resistive touch screen and capacitive touch screen. The electronic devices 100 can be mobile phones, tablet computers and other electronic devices with display in this field.

The opening size and number of the grooves 162 can be adjusted according to the width of the border 111. An extending length of grooves 162 can be adjusted according to the length of the border 111. A depth of grooves 162 can be adjusted according to the size of the border 111.

In the present disclosure, an optical thin film 14 is adhered on the cover 12; the optical thin film 14 defines optical micro-structure 16. The edges of the screen 110 and the screen cover 10 can reach the micro-refinement of visual effect, when the optical thin film 14 is adhered on the screen 110 of the electronic device 100; a narrower border effect appears, even to the point of the effect of invisible borders.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A screen cover comprising:
a cover comprising a first surface and a second surface opposite to the first surface;
an optical thin film comprising a third surface attached to the second surface and a fourth surface opposite to the third surface;
wherein the fourth surface is attached to a screen and defines an optical microstructure that is adjacent to at least one edge of the fourth surface and comprises at least one groove.

2. The screen cover of claim 1, wherein the optical microstructure comprises at least two grooves, the two adjacent grooves are adjoined and parallel to each other.

3. The screen cover of claim 2, wherein each groove extends towards extension direction which is parallel to adjacent edges.

4. The screen cover of claim 1, wherein the groove is V-shaped or arc.

5. The screen cover of claim 4, wherein the tip of V-shaped groove is a sharp corner or an arc angle.

6. The screen cover of claim 1, wherein the optical thin film is an anti-glare thin film.

7. The screen cover of claim 1, wherein both the cover and the optical thin film are transparent.

8. The screen cover of claim 1, wherein the cover is a touch screen.

9. An electronic device, comprising:
a screen cover, comprising:
a cover, comprising a first surface and a second surface opposite to the first surface;
an optical thin film comprising a third surface attached to the second surface and a fourth surface opposite to the third surface;
wherein the fourth surface is attached to a screen and defines an optical microstructure that is adjacent to at least one edge of the fourth surface and comprises at least one groove, the screen comprises a display screen area and borders, the borders surround the display screen area, and the optical microstructure is corresponding to the borders.

10. The electronic device of claim 9, wherein the borders are covered by the microstructure completely at the extension direction which is perpendicular to the grooves.

11. The electronic device of claim 9, wherein the optical microstructure comprises at least two grooves, the two adjacent grooves are adjoined and parallel to each other.

12. The electronic device of claim 11, wherein each groove extends towards extension direction which is parallel to adjacent edges.

13. The electronic device of claim 9, wherein the groove is V-shaped or arc.

14. The electronic device of claim 13, wherein the tip of V-shaped groove is a sharp corner or an arc angle.

15. The electronic device of claim 9, wherein the optical thin film is an anti-glare thin film.

16. The electronic device of claim 9, wherein both the cover and the optical thin film are transparent.

17. The electronic device of claim 9, wherein the cover is a touch screen.
